(19) United States
(12) Patent Application Publication
(10) Pub. No.: US 2025/0146796 A1
(43) Pub. Date: May 8, 2025

(54) BALLISTIC SHIELD WITH A TRANSPARENT WINDOW

(71) Applicant: Timo Olavi Tervola, Jupiter, FL (US)

(72) Inventor: Timo Olavi Tervola, Jupiter, FL (US)

(21) Appl. No.: 19/009,896

(22) Filed: Jan. 3, 2025

Related U.S. Application Data
(60) Provisional application No. 63/547,565, filed on Nov. 7, 2023.

(51) Int. Cl. F41H 5/08; B32B 5/02; B32B 5/26; B32B 27/08; B32B 27/32; F41H 5/04

(52) U.S. Cl. CPC F41H 5/08; B32B 5/02; B32B 5/26; B32B 27/08; B32B 27/32; F41H 5/0407; B32B 2307/558; B32B 2571/02; F41H 5/0471

(57) ABSTRACT

A ballistic shield is provided having a transparent window and a removable shield extension section. The ballistic shield includes a frame that receives the transparent window therein, the frame being mechanically coupled to an upper section of the ballistic shield to provide users with a line of sight through the transparent window at eye level. The frame and body of the ballistic shield are substantially coplanar. The ballistic shield further includes a removeable shield extension coupled thereto via a hinge having a hinge base, hinge clip, and a hinge pin. The hinge pin is removable to detach the shield extension and may be inserted into the hinge to affix the shield extension. The ballistic shield further includes a harness coupled to a fastener affixed thereto and to a vest shoulder strap to support a weight of the ballistic shield during use.

### CROSS-REFERENCE TO RELATED APPLICATION

This application claims priority to U.S. Provisional Application Ser. No. 63/547,565 filed on Nov. 7, 2023, the complete disclosure of which is incorporated herein by reference in its entirety.

### FIELD OF THE TECHNOLOGY

The present technology broadly relates to ballistic shields, more specifically to multi-ply ballistic shields, still more specifically to multi-ply ballistic shields having transparent windows, and still more specifically to multi-ply ballistic shields having transparent windows and a shield extension.

### BACKGROUND OF THE TECHNOLOGY

Law enforcement, military, and/or other security forces employ ballistic shields to protect themselves during dangerous situations that may include armed conflict or physical altercations. For example, ballistic shields may be employed to defeat active shooters, serve high-risk warrants, perform riot control, or the like. Ballistic shields may prevent death or injury that may result from being hit with projectiles such as bullets, rocks, bricks, bats, sticks, arrows, or the like.

### BRIEF DESCRIPTION OF THE FIGURES

The technology can be more fully understood by reading the following detailed description together with the accompanying drawings, in which like reference indicators are used to designate like elements. The drawings illustrate several examples of the technology. It should be understood, however, that the technology is not limited to the precise arrangements and configurations shown. In the drawings:

FIG. 1A illustrates a ballistic shield in front view having a transparent window at eye level according to one example of the technology;

FIG. 1B illustrates a ballistic shield in front view having the transparent window at eye level and a shield extension pivotably secured to a lower section of the ballistic shield according to another example of the technology;

FIG. 2A illustrates the ballistic shield in rear view having the transparent window at eye level according to one example of the technology;

FIG. 2B illustrates the ballistic shield in rear view having the transparent window at eye level and the shield extension pivotably secured to the lower section of the ballistic shield according to another example of the technology;

FIG. 3A illustrates the ballistic shield in a side view during use with the transparent window provided at eye level according to one example of the technology;

FIG. 3B illustrates the ballistic shield in a side view during use with the transparent window provided at eye level and the shield extension pivotably secured to a lower section of the ballistic shield according to another example of the technology;

FIG. 4A illustrates the ballistic shield in front view during use with the transparent window provided at eye level according to one example of the technology;

FIG. 4B illustrates the ballistic shield in front view during use with the transparent window provided at eye level and the shield extension pivotably secured to a lower section of the ballistic shield according to another example of the technology;

FIG. 5A illustrates a close-up of a frame that secures the transparent window to the ballistic shield, the frame is provided in a detached state according to one example of the technology;

FIG. 5B illustrates a close-up of the frame in a detached state having a cover plate provided at a lower portion of the frame according to one example of the technology;

FIG. 6 illustrates a close-up of a hinge that pivotally secures the shield extension to a lower section of the ballistic shield according to one example of the technology;

FIG. 7 illustrates a front view of a harness that secures the ballistic shield to a user according to one example of the technology;

FIG. 8 illustrates a front view of the harness provided around a strap worn by the user to secure the ballistic shield to the user according to one example of the technology;

FIG. 9 illustrates a rear view of the harness provided around the strap worn by the user to secure a ballistic shield to a user according to one example of the technology; and

FIG. 10 illustrates a rear view of the harness provided around the strap in a partially open state according to one example of the technology.

### DETAILED DESCRIPTION OF THE TECHNOLOGY

It will be readily understood by persons skilled in the art that the present disclosure has broad utility and application. In addition to the specific examples described herein, one of ordinary skill in the art will appreciate that this disclosure supports various adaptations, variations, modifications, and equivalent arrangements.

It will be appreciated that for simplicity and clarity of illustration, where appropriate, reference numerals may be repeated among the different figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, methods, procedures, and components have not been described in detail so as not to obscure the related relevant feature being described. Also, the description is not to be considered as limiting the scope of the examples described herein. The drawings are not necessarily to scale and the proportions of certain parts may have been exaggerated to better illustrate details and features of the present disclosure. Those skilled in the art with access to the teachings provided herein will recognize additional modifications, applications, and examples within the scope thereof and additional fields in which the technology would be of significant utility.

Unless defined otherwise, technical terms used herein have the same meaning as is commonly understood by one of ordinary skill in the art to which this disclosure belongs. The terms “first,” “second,” and the like, as used herein do not denote any order, quantity, or importance, but rather are used to distinguish one element from another. Also, the terms “a” and “an” do not denote a limitation of quantity, but rather denote the presence of at least one of the referenced items. The term “or” is meant to be inclusive and means either, any, several, or all of the listed items. The terms “comprising,” “including,” and “having” are used interchangeably in this disclosure. The terms “comprising,” “including,” and “having” mean to include, but are not necessarily limited to the things so described.

The terms “connected” and “coupled” can be such that the objects are permanently connected or releasably connected. The term “substantially” is defined to be essentially conforming to the thing that it “substantially” modifies, such that the thing need not be exact. For example, substantially 2 inches (2″) means that the dimension may include a slight variation.

According to one example, the multi-ply ballistic shield may be constructed from high-strength fibers, epoxy, plastic materials, or the like. According to one example, the multi-ply ballistic shield may be constructed from several layers of high-strength fibers that are mechanically or chemically bonded together. For example, the multi-ply ballistic shield may be constructed from several layers of high strength fibers that are laminated together. According to one example, multiple layers of soft pliable polyethylene film may be formed into a rigid composite ballistic shield or armor panel under extreme pressure and heat. According to one example, a multi-ply ballistic shield may improve ballistic strength based on the existence of molecular or mechanical bonds between individual layers. According to one example, impacting or penetrating projectiles may break molecular bonds when traveling between individual layers. Additionally, or alternatively, the impacting or penetrating projectiles may break mechanical bonds when traveling between individual layers. According to one example, the act of breaking molecular or mechanical bonds between individual layers causes the impacting or penetrating projectiles to dissipate kinetic energy, thereby slowing down the projectiles.

During a first phase of projectile entry into a ballistic shield, the projectile nose shears or tears several surface layers of the high-strength fibers upon impact, which may puncture holes therethrough. According to one example, a high velocity projectile with a small leading surface area may cause shearing and puncturing of several layers of high-strength fibers. For example, the penetrating projectile generates frictional forces between the projectile nose and the high-strength fibers that in turn generate thermal energy sufficient to melt or shear the high-strength fibers, which may form holes therethrough. According to one example, the ballistic shield is less effective at stopping projectiles during this first phase when layers of the ballistic shield are pierced, compared to being separated or delaminated. According to one example, the leading surface area of the armor increases as the projectile nose blunts under the forces of the first phase of projectile entry. This causes the armor to generally deform, not shear. For example, the impact forces may blunt the projectile or strip the jacket off the projectile. When the projectile deforms or blunts by a sufficient amount, the high-strength armor fibers may stop shearing. As a result, the projectile may cease shearing or forming holes through the layers of the ballistic shield. According to one example, the first phase of projectile entry may cause minimal layer delamination.

According to one example, a second phase of projectile penetration into the ballistic shield begins when the projectile is sufficiently blunt and includes enough leading surface area to delaminate underlying layers. According to one example, the impacting or penetrating projectiles impart separation forces that delaminate underlying layers. According to one example, the delaminated layers may be physically displaced. For example, the delaminating layers may be physically displaced in lateral or rearward directions, away from a penetrating face of the multi-ply ballistic shield. According to one example, the physically displaced layers may capture the penetrating projectiles within the ballistic shield. In other words, the underlying layers form the equivalent of a catcher's mitt to stop the penetrating projectile from advancing through the layers. Stated differently, the penetrating projectiles may be prevented from traveling through layers and exiting the multi-ply ballistic shield.

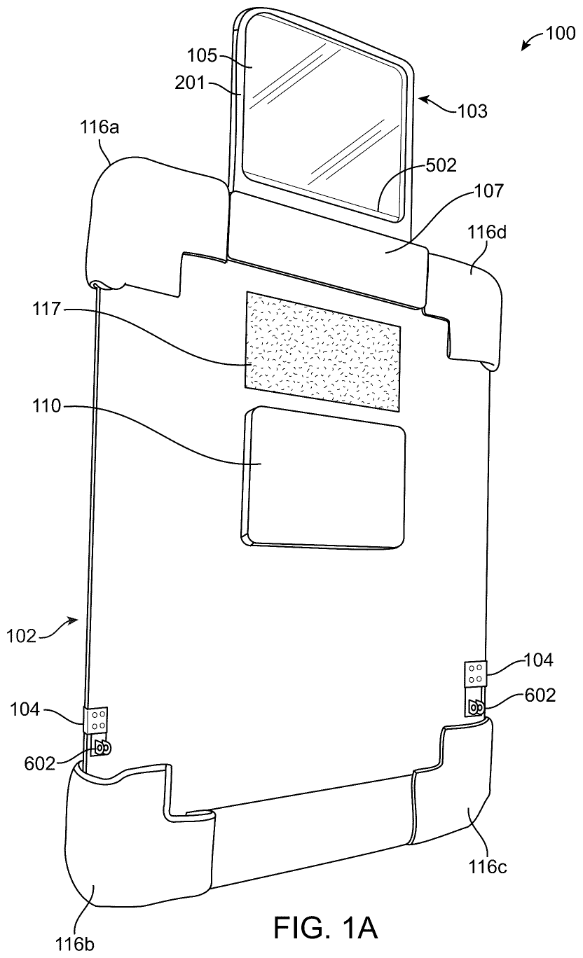

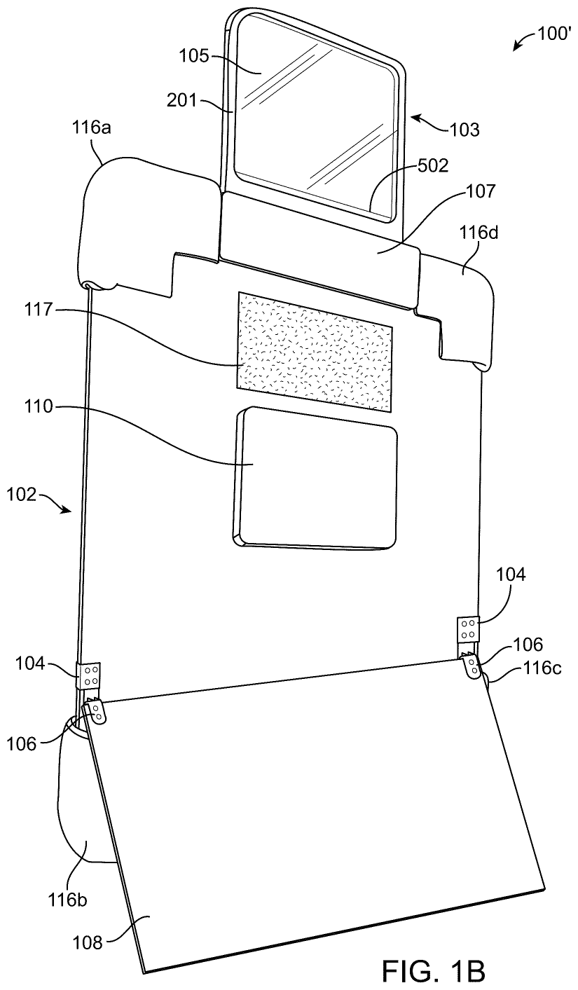

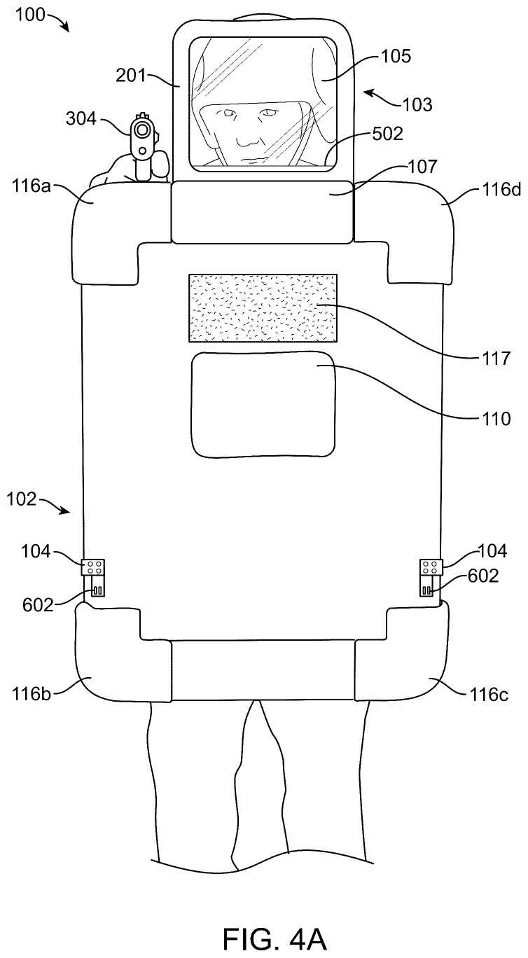

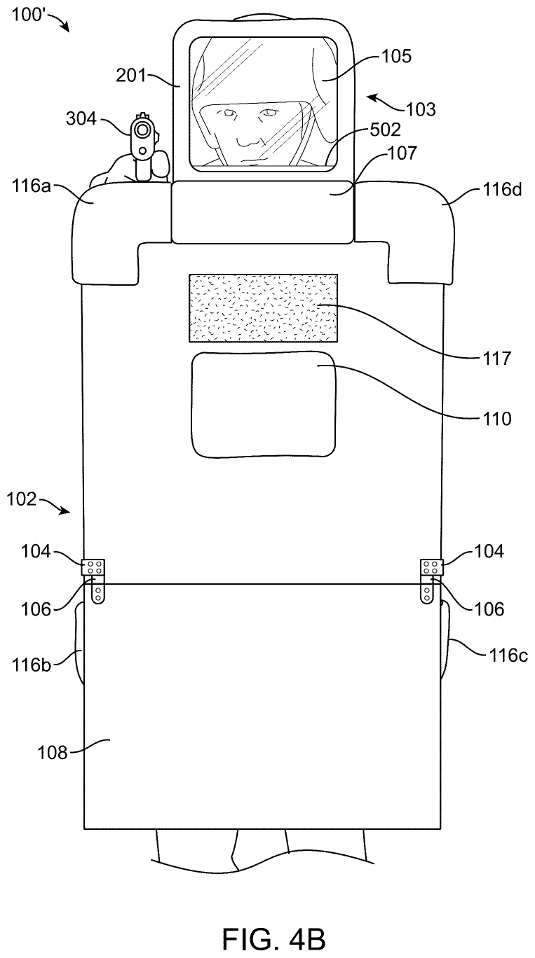

FIG. 1A illustrates a front view of the multi-ply ballistic shield 100 according to one example of the technology. According to one example, the ballistic shield 100 may be shaped or dimensioned to correspond to a human body contour. For example, the ballistic shield 100 may include a first section 102 and a second section 103, among other sections. According to one example, the second section 103 may include a frame 201 and a transparent window 105. With reference to FIG. 4A, the first section 102 may be dimensioned to protect a human torso while the second section 103 may be dimensioned to protect a human head. According to one example, the first and second sections 102,103 are coplanar. According to one example, the first section 102 is coplanar with the frame 201 and the transparent window 105. FIG. 1A illustrates the front view or an outward face of the ballistic shield 100. According to one example, the outward face receives a projectile and is thus termed a penetrating face of the ballistic shield 100.

FIG. 1B illustrates a front view of the multi-ply ballistic shield 100′ according to another example of the technology. According to one example, the ballistic shield 100′ may include the first section 102, the second section 103, and a removable third section 108, among other sections. With reference to FIG. 4B, the first section 102 may be dimensioned to protect a human torso, the second section 103 may be dimensioned to protect a human head, and the third section 108 may be dimensioned to protect a groin or upper leg area. FIG. 1B illustrates the front view or an outward face of the ballistic shield 100′. According to one example, the outward face receives a projectile and is thus termed a penetrating face of the ballistic shield 100′.

FIGS. 1A and 1B illustrates pads 116a-116d that may be applied to edges of the first section 102. According to one example, the pads 116a-116d may protect edges of the ballistic shield 100,100′ from becoming damaged. Alternatively, or additionally, the pads 116a-116d may protect users of the ballistic shield 100,100′ from becoming injured. According to one example, a hook and loop patch 117 may be provided on the first section 102. For example, the hook and loop patch 117 may be provided on the outward face of the first section 102 to receive accessories thereon. For example, the hook and loop patch 117 may receive a light mounted or coupled to an outward face of the ballistic shield 100,100′.

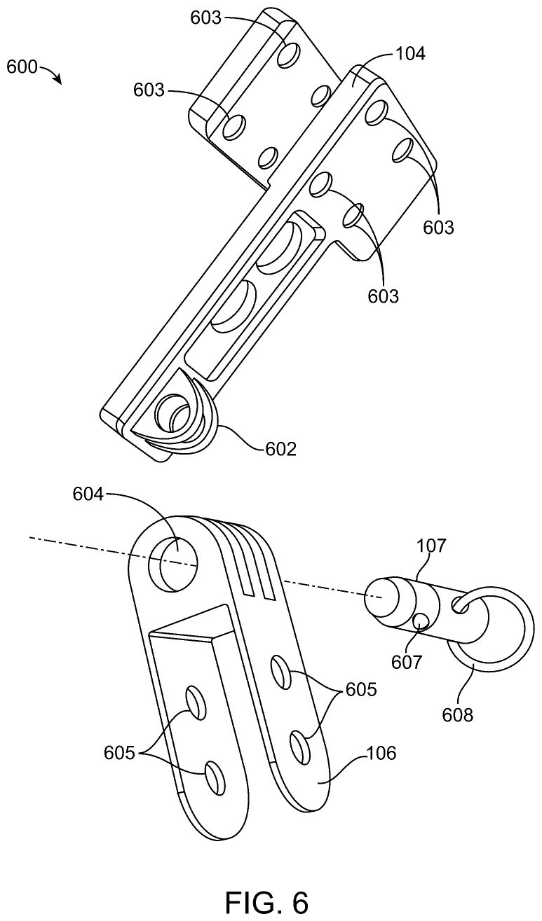

FIGS. 1A and 1B illustrate the first section 102 having hinge bases 104 fixedly secured thereto. FIG. 6 illustrates a hinge 600 according to one example of the technology. According to one example, the hinge 600 may include the hinge base 104, a hinge clip 106, and a hinge pin 107, among other components. According to one example, the hinge base 104 may include a barrel 602 adapted to receive the hinge pin 107 therethrough. According to one example, the hinge base 104 further may include apertures 603 that receive fasteners therethrough to couple the hinge base 104 to an object such as the first section 102. For example, the fasteners may include screws, bolts, rivets, or the like. According to one example, the hinge 600 may further include a hinge clip 106 with an aperture 604 adapted to receive the hinge pin 107 therethrough. According to one example, the hinge clip 106 may include apertures 605 that receive fasteners therethrough to couple the hinge clip 106 to an object such as the third section 108, as illustrated in FIG. 1B. For example, the fasteners may include screws, bolts, rivets, or the like. According to one example, the hinge clip 106 may be generally U-shaped to couple to the planar third section 108. According to one example, the hinge clip 106 is configured to pivot about the hinge pin 107. One of ordinary skill in the art will readily appreciate that the hinge clip 106 may be formed of other shapes to couple to objects having different shapes.

According to one example, the hinge 600 may be releasably assembled by aligning the aperture 604 of the hinge clip 106 with the barrel 602 of the hinge base 104. Once aligned, the hinge pin 107 may be inserted through the barrel 602 and the aperture 604. According to one example, the hinge pin 107 may include a securing mechanism such as a spring loaded ball 607. According to one example, the spring loaded ball 607 may retract into the hinge pin 107 when contacting an inside surface of the aperture 604 or the aperture in the barrel 602. Once the spring loaded ball 607 is fully inserted into the hinge 600, the spring loaded ball 607 will bias outward to prevent the hinge pin 607 from exiting through the aperture 604 and the aperture in the barrel 602. However, the hinge pin 107 may be removed by a user forcefully pulling a ring 608 provided at the end of the hinge pin 107 in a direction away from the hinge 600. According to one example, the assembled hinge 600 allows the hinge clip 106 to pivot about the hinge pin 107 relative to the stationary hinge base 104. According to another example, the hinge 600 may be disassembled by removing the hinge pin 107 from the barrel 602 and the aperture 604 by pulling the ring 608 in a direction away from the hinge 600. According to one example, the hinge 600 may be disassembled to detach the third section 108 from the first section 102.

FIG. 1B illustrates the hinge 600 in an assembled state with the third section 108 attached, while FIG. 1A illustrates the hinge 600 in a disassembled state with the third section 108 removed. According to one example, the hinge 600 allows the third section 108 to be both pivotably and releasably coupled from the first section 102. According to one example, the third section 108 may be coupled or released as needed to extend a length of the ballistic shield 100′. For example, the length of the ballistic shield 100′ may be extended during combat situations that require protection of the groin or upper leg area. Alternatively, the third section 108 may be detached or removed from the first section 102 by pulling the hinge pins 107 from assembled hinges 600. According to one example, the third section 108 may be decoupled or removed to reduce a size of the ballistic shield 100′ prior to entering a small space such as an attic or other tight quarters. Additionally, the third section 108 may be removed to transport the ballistic shield 100,100′.

According to one example, the first section 102 and the third section 108 each may be of unitary construction. In other words, the first and third sections 102,108 may be constructed of multiple single-pattern fabric layers that are mechanically or chemically bonded together. For example, the first section 102 may include a single fabric pattern per layer that is dimensioned to conform to a shape of a human torso or the like. Furthermore, the third sections 108 may include a single fabric pattern per layer that is dimensioned to conform to any desired shape such as square, rectangular, or the like. To be clear, the first and third sections 102, 108 may not be constructed from a patchwork of fabric patterns such as two or more fabric patterns per layer that are pieced together to form desired shapes for the first and third sections 102,108.

According to one example, the second section 103 may be constructed from a transparent material or window 105. For example, the second section 103 may be constructed from a transparent ceramic material such as aluminium oxynitride or the like. According to one example, aluminium oxynitride is selected for desired properties such as being transparent, bulletproof, and blast-resistant, among other properties. Alternatively, the technology may employ glass-clad polycarbonate or the like. Aluminum oxynitride is a polycrystalline ceramic made from powder. According to one example, aluminum oxynitride may remain clear despite being impacted by rounds from small-caliber weapons. Compared to other bulletproof glass, aluminum oxynitride will not warp, fog, or spiderweb when impacted by a projectile.

Additionally, aluminum oxynitride is optically transparent in the near-ultraviolet, visible, and mid-wave-infrared regions of the electromagnetic spectrum.

According to one example, the second section 103 may be positioned at eye level along a sight line employed while carrying the ballistic shield 100,100′. For example, the second section 103 may be coupled to the first section 102 at one or more locations that correspond to a user's eye level or sight line. According to one example, the second section 103 may be positioned along a periphery of the ballistic shield 100,100′. With reference to FIGS. 1A and 1B, the second section 103 may be positioned along an upper edge of the first section 102 such that the transparent window 105 is aligned with a user's eye level or natural sight line while carrying the ballistic shield 100,100′. According to one example, the second section 103 may be positioned relative to the first section 102 such that the user may see through the transparent window 105 while using the ballistic shield 100,100′, without needing to modify a grip or a carrying position of the ballistic shield 100, 100′. In other words, the second section 103 is positioned to allow the user to maintain a natural gaze and stance while holding the ballistic shield 100,100′. In other words, the technology does not require the user to modify a stance or change a line of sight while using the ballistic shield 100,100′. For example, the user will not need to unnaturally look down through the transparent window 105 or unnaturally elevate the ballistic shield to gaze through the transparent window 105.

According to one example, the second section 103 may be positioned to align with a user's eye level or natural sight line when the ballistic shield 100 is carried in combat. According to an alternative example, the second section 103 may be arranged so the transparent window 105 extends along any length or direction of the ballistic shield 100. For example, the second section 103 may be arranged so the transparent window 105 extends vertically, horizontally, diagonally, or the like along the ballistic shield 100, relative to the ground. For example, the second section 103 may be configured so the transparent window 105 extends vertically along a center line of the ballistic shield 100, relative to the ground. In this case, the first section 102 may flank both sides of a vertically extending second section 103. Still further, the second section 103 may be configured so the transparent window 105 extends along the ballistic shield 100 in any combination of vertical, horizontal, or diagonal, relative to the ground. According to another example, the second section 103 may be configured so the transparent window 105 forms a V-shape or the like on the ballistic shield 100,100′. One of ordinary skill in the art will readily appreciate that the second section 103 may be arranged so the transparent window 105 is provided in other arrangements, configurations, or orientations to enhance visibility or utility while using the ballistic shield 100,100′.

According to one example, the second section 103 may be dimensioned to provide unobstructed views of a desired target while using the ballistic shield 100,100′. For example, the second section 103 may be dimensioned to allow users to view desired targets via a natural line of sight. According to one example, the second section 103 may be coupled to the first section 102 in a non-coplanar manner (not illustrated). For example, the second section 103 may form an angle relative to the first section 102. According to one example, the second section 103 may be tilted relative to the first section 102. For example, the second section 103 may be coupled to the first section 102 at a tilt angle between 1° to 90° or the like. In addition, or in the alternative, the second section 103 may include a non-planar shape. For example, the second section 103 may include a curved shape or the like. For example, the second section 103 may be curved toward or around a user's head or neck. According to one example, a curved second section 103 may protect a user from projectiles that originate from lateral or sideway directions.

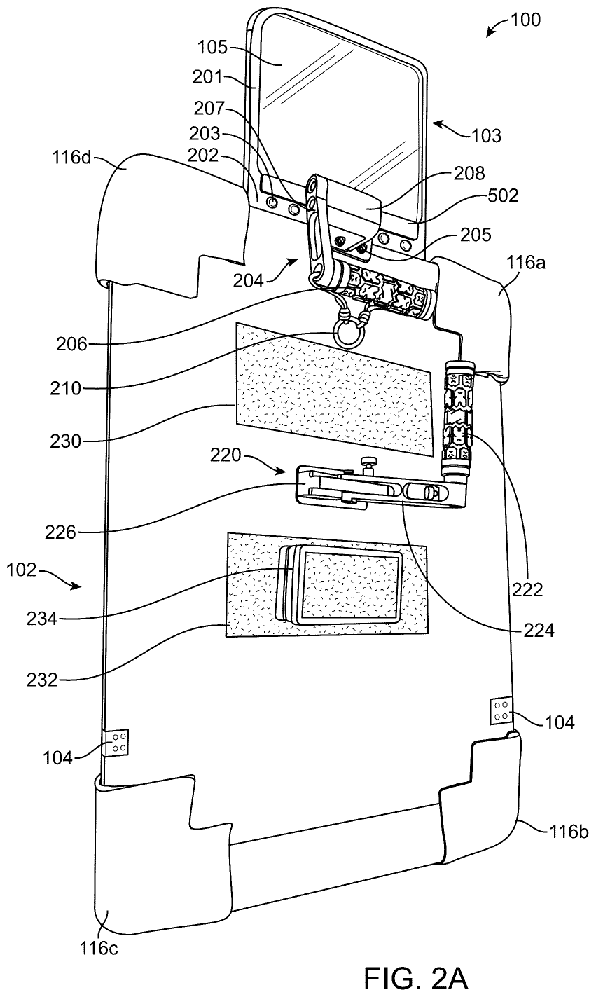

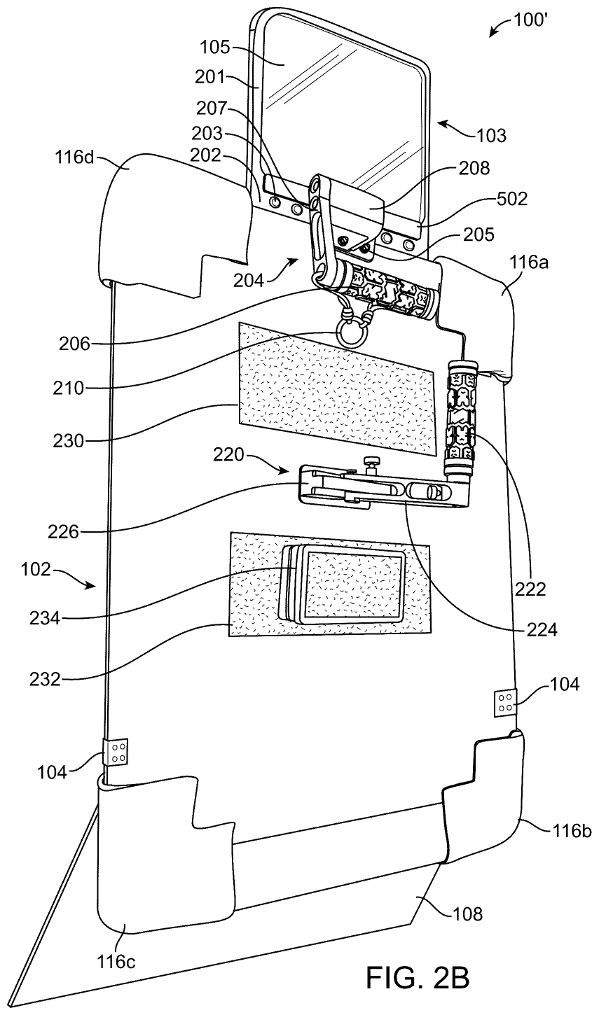

FIG. 2A illustrates an inward face of the ballistic shield 100 according to one example of the technology. According to one example, the second section 103 may include a frame 201 provided along a periphery of the transparent window 105. According to one example, the frame 201 may be constructed from metal, plastic, or the like. According to one example, the frame 201 may include a border or an edge structure that may be bonded or coupled to a periphery of the transparent window 105. According to one example, the transparent window 105 may be mechanically coupled, bonded, or fixedly secured to the edge structure of the frame 201. For example, the transparent window 105 may be affixed, adhered, or otherwise secured to one or more sides of the frame 201. For example, the transparent window 105 may be adhered to one or more sides of the frame 201 using glue, epoxy, or the like. Additionally, or alternatively, the transparent window 105 may be mechanically coupled to one or more sides of the frame 201 using fasteners such as screws, bolts, rivets, or the like. According to one example, the second section 103 may include the frame 201 having a bracket 202 that fastens to an object. For example, the bracket 202 of the frame 201 may be employed to fasten the second section 103 to the first section 102. According to one example, the bracket 202 may include one or more apertures 203 that receive fasteners therethrough. For example, fasteners may include bolts, screws, rivets, or the like. According to one example, the apertures 203 may be patterned to align with corresponding apertures provided in the first section 102.

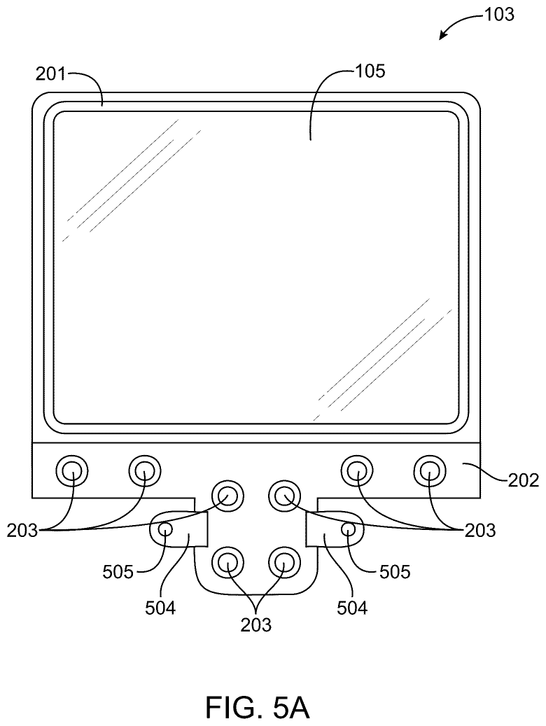

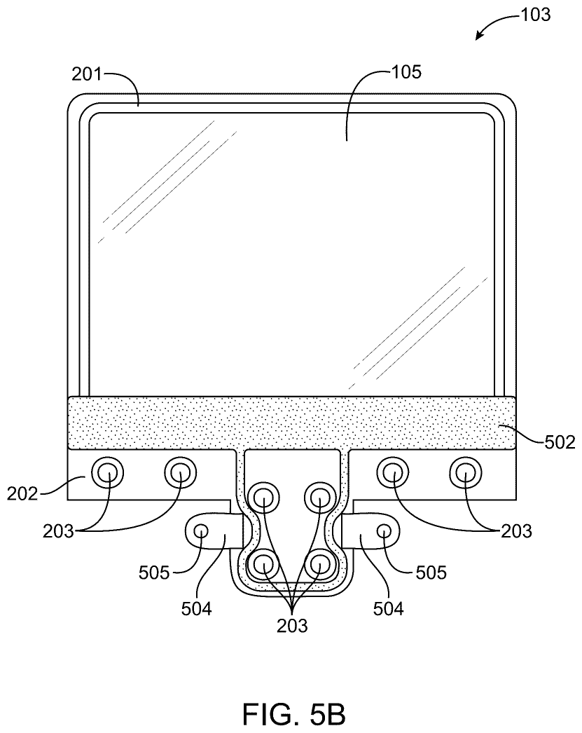

FIGS. 5A and 5B illustrate close-ups of the second section 103 in a detached state. According to one example, the frame 201 may include an L-shaped contour having first and second edges along a perimeter of the transparent window 105. According to one example, the first and second edges may be substantially perpendicular to each other. According to one example, the frame 201 may include an open side that receives the transparent window 105 therein. According to one example, the first edge may restrict lateral or sideway movement of the transparent window 105. According to one example, the second edge may restrict vertical movement of the transparent window 105 through the frame 201. In other words, the second edge may abut the transparent window 105 placed within the frame 201 to stop further movement through the frame 201. According to one example, the first edge of the frame 201 may be dimensioned similar to a thickness of the transparent window 105. According to one example, the second edge of the frame 201 may be dimensioned similar to the first edge to extend into a periphery of the transparent window 105. One of ordinary skill in the art will readily appreciate that the second edge may be dimensioned longer to provide more contact surface area or shorter to provide a larger viewing area.

According to one example, the transparent window 105 may be coupled to the frame 201. For example, the transparent window 105 may be coupled to the first and second edges the frame 201. According to one example, the transparent window 105 may be coupled to the frame 201 using glue, epoxy, or the like. For example, an epoxy may be applied along the first and second edges of the frame 201 to couple the transparent window 105 thereto. Additionally, or alternatively, the transparent window 105 may be mechanically coupled to the frame 201 using fasteners such as screws, bolts, rivets, or the like. For example, bolts may be provided to couple the transparent window 105 and the second edge of the frame 201. Additionally, or alternatively, screws may be provided to pass through the first edge of the frame 201 into the transparent window 105.

According to one example, the frame 201 may protect edges of the transparent window 105 from damage. For example, the frame 201 may protect edges of the transparent window 105 in an event the second section 103 of the ballistic shield 100 is struck, dropped, or bumped. According to one example, the bracket 202 of the frame 201 may be employed to fasten the second section 103 to an object such as the first section 102. According to one example, the bracket 202 may include one or more apertures 203 that receive fasteners therethrough. For example, fasteners may include bolts, screws, rivets, or the like. According to one example, the apertures 203 may be patterned to align with corresponding apertures provided in the first section 102.

FIG. 5B illustrates a cover plate 502 provided along a lower portion of the frame 201 to overlap both the transparent window 105 and the bracket 202. According to one example, the cover plate 502 adds redundancy to further physically couple or secure the transparent window 105 within the bracket 202. For example, the cover plate 502 may be provided to physically couple or sandwich the transparent window 105 between the cover plate 502 and the second edge of the frame 201. According to one example, the cover plate 502 effectively provides a third edge opposite the second edge of the frame 201. For example, the cover plate 502 may turn the L-shaped contour into a U-shaped contour along the lower portion of the frame 201. According to one example, the cover plate 502 may prevent the transparent window 105 from falling out of the frame 201 in a direction away from the second edge. For example, the cover plate 502 may prevent the transparent window 105 from falling out of the frame 201 such as when impacted by a projectile.

According to one example, the cover plate 502 adds mechanical strength by pressing the transparent window 105 against the second edge of the frame 201. According to one example, the cover plate 502 will maintain the transparent window 105 within the frame 201 when a projectile impacts the transparent window 105. For example, the cover plate 502 will maintain the transparent window 105 within the frame 201 when a projectile impacts the transparent window 105 from a direction originating from the outward face. Accordingly, the cover plate 502 supplements the structural integrity of the frame 201 by providing a physical barrier at the inward side of the frame 201. According to one example, the cover plate 502 presses the transparent window 105 between two physical barriers that include the second edge and the cover plate 502 itself. According to one example, the frame 201 may include tabs 504 having apertures 505 to physically secure the cover plate 502 thereto. For example, fasteners such as screws, bolts, rivets, or the like, may be provided through the apertures 505 to secure the cover plate 502 to the frame 201. One of ordinary skill in the art will readily appreciate that the cover plate may extend further along a periphery of the frame and that fasteners may be employed to mechanically couple or secure the cover plate 502 and the frame 201.

According to an alternative example, the second section 103 may omit a frame along a periphery of the transparent window 105. In this case, the transparent window 105 may be coupled directly to the first section 102. Furthermore, while the second section 103 is illustrated as planar, the technology contemplates non-planar configurations. For example, the second section 103 may include a curved shape. According to one example, a curve-shaped second section 103 may protect a user from projectiles that originate from lateral directions or from above the ballistic shield 100. In addition, or in the alternative, the second section 103 may be coupled to the first section 102 in a non-planar fashion. For example, the second section 103 may be offset by an angle relative to the first section 102. According to one example, an offset angle may be selected to protect users from projectiles that original from lateral directions or from above the ballistic shield 100.

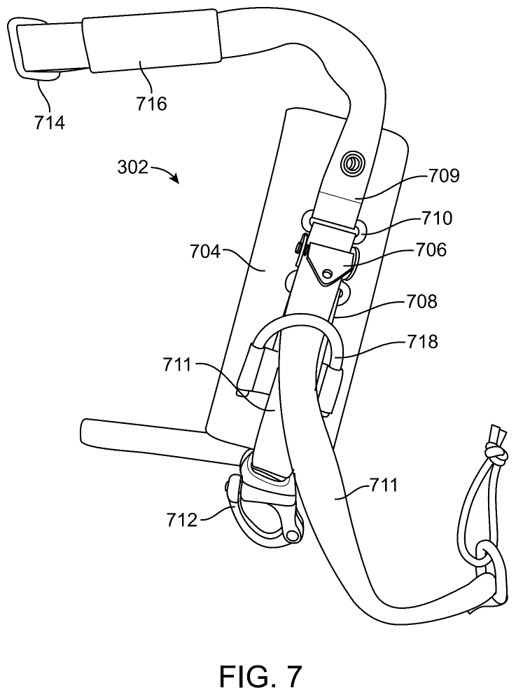

Returning again to FIG. 2A, the first section 102 may include a first handle mechanism 204 that is mechanically coupled to the frame 201. For example, the first handle mechanism 204 may be mechanically coupled to the frame 201 using fasteners 205 such as screws, bolts, rivets, or the like. According to one example, the first handle mechanism 204 may abut the first section 102. According to one example, the first handle mechanism 204 may include a first grip 206. According to one example, the first handle mechanism 204 may include a first arm 207 that pivots at a base 208 to fixedly secure the first grip 206 in one of various positions. For example, FIG. 2A illustrates the first grip 206 fixedly secured in a downward position. According to one example, the first arm 207 may pivot at the base 208 to fixedly secure the first grip 206 in a substantially perpendicular orientation relative to the first section 102. Furthermore, the first arm 207 may pivot at the base 208 to fixedly secure the first grip 206 in an upward position. Still further, the first arm 207 may pivot at the base 208 to fixedly secure the first grip 206 in any position between the upward and downward positions. According to one example, a fastener 210 may be secured to the first handle mechanism 204. For example, the fastener 210 may be secured to the first grip 206 in order to secure a harness thereto as described below with reference to FIGS. 7-10. According to one example, the fastener 210 may include a ring or the like. One of ordinary skill in the art will readily appreciate that the first arm 207 may be provided at opposite sides of the base 208 to accommodate left-handed or right-handed users.

According to one example, the first section 102 may include a second handle mechanism 220 mechanically coupled thereto. For example, the second handle mechanism 220 may be mechanically coupled to the first section 102 using fasteners such as screws, bolts, rivets, or the like. According to one example, the second handle mechanism 220 may directly abut the first section 102. According to one example, the second handle mechanism 220 may include a second grip 222. According to one example, the second handle mechanism 220 may include a second arm 224 that pivots at a base 226 to fixedly secure the second grip 222 in one of various positions. For example, FIG. 2A illustrates the second grip 422 fixedly secured in a rightward position. According to one example, the second arm 224 may pivot at the base 226 to fixedly secure the second grip 222 in a substantially perpendicular orientation relative to the first section 102. Furthermore, the second arm 224 may pivot at the base 226 to fixedly secure the second grip 222 in a leftward position. Still further, the second arm 224 may pivot at the base 226 to fixedly secure the second grip 222 in any position between the rightward and leftward positions. One of ordinary skill in the art will readily appreciate that the second arm 224 may be inverted such that the second grip 222 is directed downward rather than upward as depicted in FIG. 2A. Still further, the second arm 224 may be removed to provide a different mode of use.

FIG. 2B illustrates an inward face of the ballistic shield 100′ according to another example of the technology. According to one example, the ballistic shield 100′ may include the first section 102, the second section 103, and the removable third section 108, among other sections. According to one example, the hinge base 104 is mechanically coupled to the first section 102 to pivotably secure the removable third section 108 having the hinge clip 106 affixed thereto. According to one example, hook and loop patches 230,232 may be provided on the first section 102. For example, the hook and loop patches 230,232 may be provided on an inward face of the first section 102. According to one example, risers 234 may be stacked on the hook and loop patches 230,232 to elevate a contact point relative to a surface of the first section 102. For example, the risers 234 maybe stacked on the hook and loop patches 230, 232 to elevate the contact point such that a user's body part may comfortably engage the first section 102 during use. Still further, the risers 234 may provide padding to users.

Returning to FIGS. 1A and 1B, the first section 102 may include a first offset layer 107 mechanically coupled thereto. For example, the first offset layer 107 may be mechanically coupled to the first section 102 using fasteners such as screws, bolts, rivets, or the like. According to one example, the first offset layer 107 may be positioned over a boundary area provided between the first section 102 and the second section 103. A reason for providing an offset layer is that the ballistic shield 100,100′ may be weakened at locations penetrated by fasteners. Accordingly, a projectile hitting the boundary area may more easily penetrate the ballistic shield 100, 100′ since the boundary area between the first section 102 and the second section 103 may be weakened due to having several fasteners therethrough. According to one example, the first offset layer 107 may completely stop a projectile, leaving the first section 102 unaffected.

According to one example, the first offset layer 107 may be vertically offset from the ballistic shield 100, 100′ via an air gap provided between the first section 102 and the first offset layer 107. According to one example, the air gap may provide an offset between the first section 102 and the first offset layer 107. Alternatively, the air gap may be eliminated and the first offset layer 107 may directly contact or abut the first section 102. According to another example, a projectile may penetrate through the first offset layer 107 and may enter the air gap with less mass and reduced velocity prior to impacting the first section 102. In this case, the first offset layer 107 offers several benefits to the underlying first section 102, including a reduced threat of defeating the first section 102 and improved shot spacing performance, among other benefits. With respect to the reduced threat of defeating the first section 102, the reduced mass and velocity of projectiles that may exit the first offset layer 107 may minimize or prevent the first section 102 from experiencing the first phase of projectile entry. According to one example, shot spacing refers to a physical distance between adjacent projectile impacts. If an area of the ballistic shield 100,100′ is compromised due to the first phase of projectile entry or the second phase of projectile penetration, a greater or larger shot spacing is needed to stop a subsequent projectile of equivalent threat. The first offset layer 107 may eliminate or significantly reduce exposure of the first section 102 to the first phase of projectile entry, thereby improving shot spacing performance.

For reasons similar to those discussed above, the first section 102 may include a second offset layer 110 mechanically coupled thereto. For example, the second offset layer 110 may be mechanically coupled to the first section 102 using fasteners such as screws, bolts, rivets, or the like. According to one example, the second offset layer 110 may be positioned over the second handle mechanism 220 coupled to the ballistic shield 100,100′ via fasteners. Again, a reason for providing an offset layer is that the ballistic shield 100,100′ may be weakened at locations penetrated by fasteners. According to one example, an air gap may be provided between the first section 102 and the second offset layer 110. According to one example, the air gap may provide an offset between the first section 102 and the second offset layer 110. For example, the second offset layer 110 may be vertically offset from the first section 102 via the air gap. Alternatively, the air gap may be eliminated and the second offset layer 110 may directly contact or abut the first section 102.

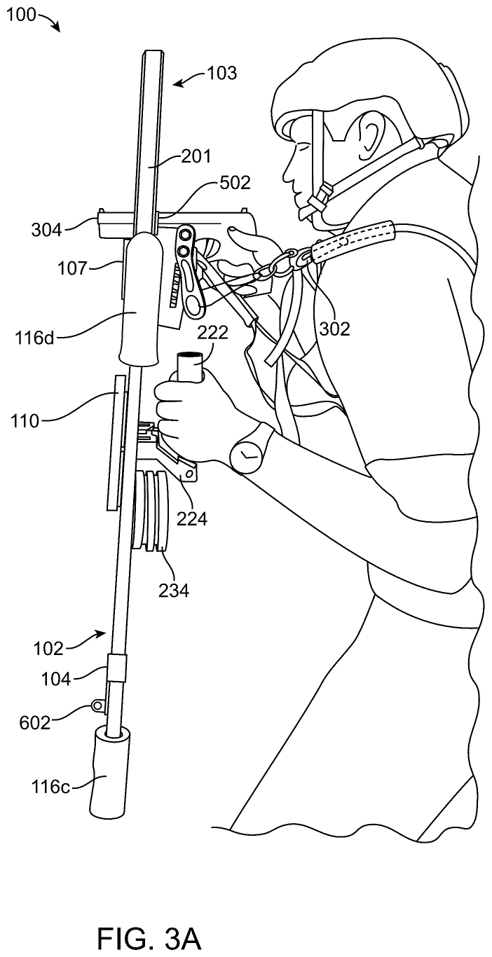

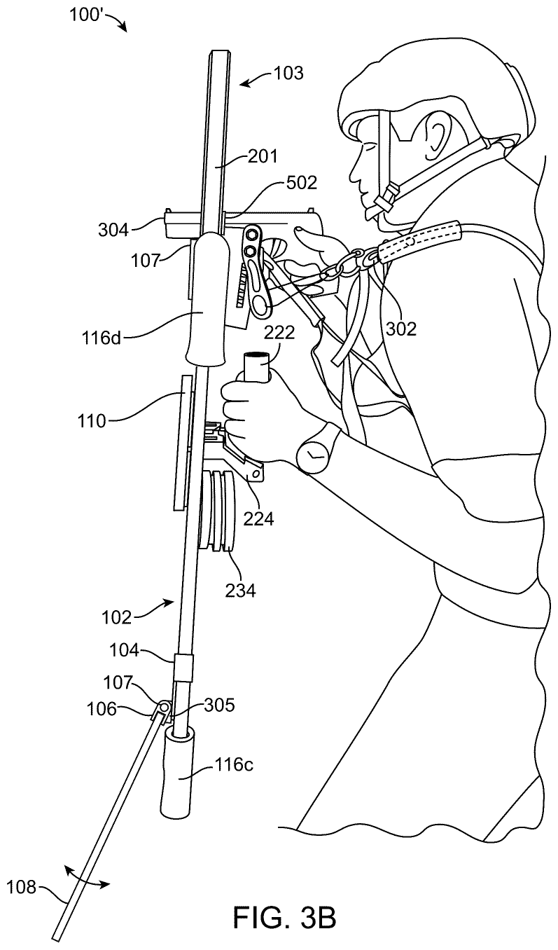

FIG. 3A illustrates a side view of the multi-ply ballistic shield 100 in use according to one example of the technology. According to one example, the ballistic shield 100 includes the fastener 210 that may be mounted to the upper grip 206 as illustrated in FIG. 2A. According to one example, a harness 302 may be secured to a vest shoulder strap and may clip to the fastener 210 to support a majority of the weight attributed to the ballistic shield 100. According to one example, the user may rest a firearm 304 on the pad 116a of the multi-ply ballistic shield 100 as illustrated in FIG. 4A. According to one example, the user may grasp the lower grip 222 with a free hand to maneuver the ballistic shield 100. For example, the user may maneuver the ballistic shield 100 to position the firearm 304 a comfortable distance relative to the user's body. According to one example, a comfortable distance may allow the user to aim and discharge the firearm 304 with desired accuracy. One of ordinary skill in the art will readily appreciate that a user may be left-handed and thus may rest the firearm 304 on the pad 116d of the ballistic shield 100. In this case, the user may grasp the lower grip 222 with a right hand to maneuver the ballistic shield 100 a comfortable distance relative to the user's body to aim and discharge the firearm 304 with desired accuracy. FIGS. 4A and 4B illustrate a front view of the ballistic shield 100,100′ in use according to one example of the technology, with the user looking through the second section 103.

FIG. 3B illustrates a side view of the multi-ply ballistic shield 100′ in use according to another example of the technology. According to one example, the ballistic shield 100′ may include the first section 102, the second section 103, and the removable third section 108, among other sections. According to one example, the hinge base 104 is mechanically coupled to the first section 102 via a hinge pin 107 to pivotably secure the third section 108 having the hinge clip 106 affixed thereto. According to one example, the hinge clip 106 may include a bumper 305 that biases the third section 108 in a forward direction. For example, the bumper 305 may be wedge-shaped or the like. According to one example, the third section 108 may be slightly biased in a forward direction when the ballistic shield is held or positioned vertically. According to one example, the slight forward direction bias allows the third section 108 to pivot or swing forward when the ballistic shield 100 contacts an object below such as the ground during use. In this way, the third section 108 may be biased away from the user's body so as not to interfere with an operation. For example, the third section 108 may be biased at least 10° forward of a plane defined by the first section 102.

FIG. 4A illustrates a front view of the multi-ply ballistic shield 100 in use according to one example of the technology, with the user looking through the second section 103. FIG. 4B illustrates a front view of the multi-ply ballistic shield 100′ in use according to another example of the technology, with the third section 108 protecting the user's groin or upper leg area and the user looking through the second section 103.

FIG. 7 illustrates a front view of the harness 302 according to one example of the technology. According to one example, the harness 302 may include a main body 704.

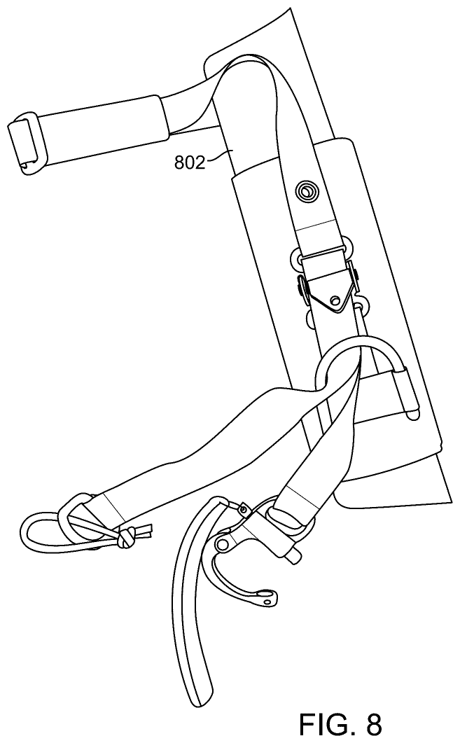

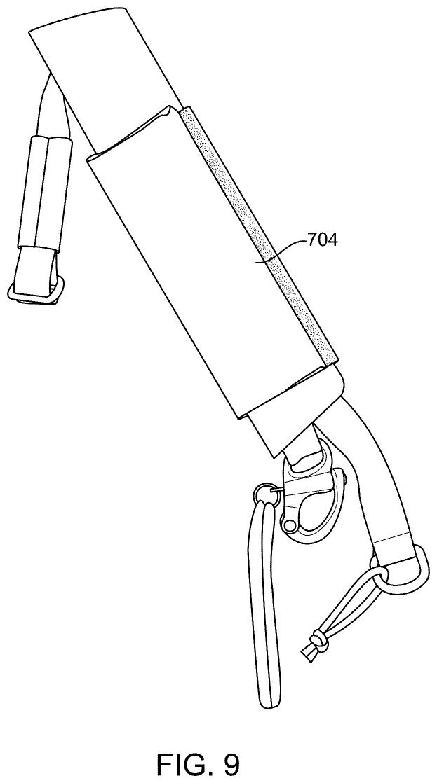

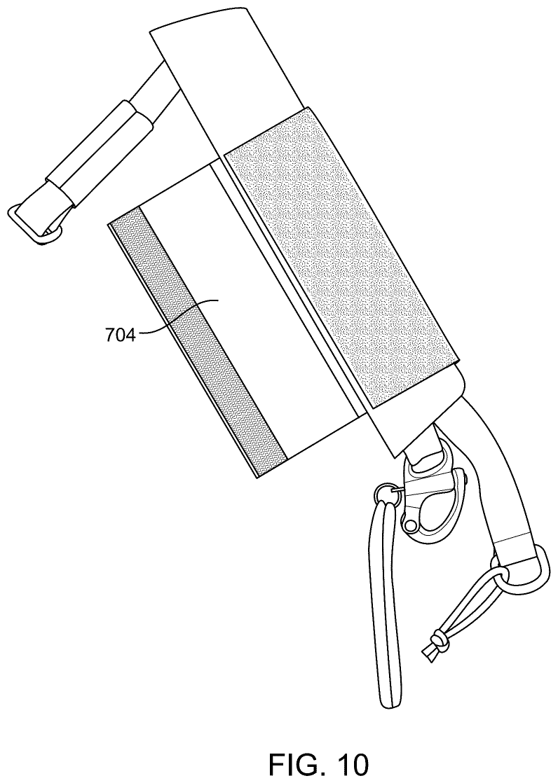

According to one example, the harness 302 may include a cam buckle 706 that is secured to the main body 704 using straps such as woven straps. According to one example, the cam buckle 706 may be secured to the main body 704 using an attaching strap 708 and an anchor strap 709. For example, the attaching and anchor straps 708,709 may be secured to the main body 704 via stitching or the like. According to one example, the securing and anchor straps 708,709 may be secured together using a strap ring 710. According to one example, an adjustment strap 711 may be provided through the cam buckle 706 to allow a user to adjust a carrying distance between the harness 702 and the ballistic shield 100,100′. According to one example, the adjustment strap 711 may include a snap shackle 712 that is mechanically coupled to the shield fastener 210 during use. According to one example, the anchor strap 709 may be secured to MOLLE webbing or a pouch attachment ladder system (PALS) worn by the user. For example, the anchor strap 709 may be secured to MOLLE webbing or the PALS using a buckle 714. According to one example, a sheath 716 may be slipped over the buckle 714 to minimize slipping of the anchor strap 709 in the buckle 714. According to one example, the harness 302 may include a guide 718 that minimizes lateral movement of the adjustment strap 711 during use. FIG. 8 illustrates the harness 302 secured around an object 802 that a user may wear on his upper body to support the ballistic shield 100,100′. FIG. 9 illustrates a rear view of the harness 302. FIG. 10 illustrates a rear view of the harness 302 with the main body 704 partially opened. According to one example, the main body 704 may include a tri-fold structure that employs a hook and loop fastening mechanism.

According to one example, the first and third sections 102, 108, along with the first and second offset layers 107,110, may be constructed from ultra-high-molecular-weight polyethylene (“UHMWPE”). UHMWPE is a subset of thermoplastic polyethylene and has extremely long chains that transfer load more effectively to the polymer backbone by strengthening intermolecular interactions. This results in a very tough material, with the highest impact strength of any thermoplastic polyethylene. For personal armor, the fibers may be aligned and bonded into sheets that are layered at various angles to give the resulting composite material strength in all directions. A completed multi-ply ballistic shield 100, 100′ may include a range of layer counts and layer thicknesses, both for individual layers and a total finished product. According to one example, the thickness of the finished product may depend upon the desired ballistic capabilities and the type of raw ballistic material employed. Generally, for rifle threats, a total product thickness may range from 5 millimeters to 15 millimeters thick and may vary from 60 layers to 120 layers thick. One of ordinary skill in the art will readily appreciate that total product thickness and the layer count may be reduced for handgun threats. According to one example, the first and third sections 102,108 may be constructed from 100 ply sheets or greater. According to one example, the first and second offset layers 107,110 may be constructed from 90 ply sheets or greater. According to one example, the multi-ply ballistic shield 100,100′ improves ballistic strength and a weight or density to performance ratio.

While the foregoing illustrates and describes examples of this technology, it is to be understood that the technology is not limited to the constructions disclosed herein. The technology may be embodied in other specific forms without departing from its spirit. Accordingly, the appended claims are not limited by specific examples described herein.

What is claimed is:

1. A ballistic shield, comprising:
a first section having an outward face exposed to projectiles and an opposing inward face; and
a second section comprising:
a frame mechanically coupled to the first section, the frame being substantially coplanar with the first section; and
a transparent window mechanically coupled to the frame.

2. The ballistic shield according to claim 1, wherein the first section is dimensioned to protect a human torso and the second section is dimensioned to protect a human head.

3. The ballistic shield according to claim 1, further comprising a first offset layer provided over a boundary area provided between the first section and the second section.

4. The ballistic shield according to claim 1, further comprising a first handle mechanism mechanically coupled to the frame, the first handle mechanism having a first arm that pivots at a base to fixedly secure a first grip in one of various positions.

5. The ballistic shield according to claim 1, further comprising a second handle mechanism mechanically coupled to the inward face, the second handle mechanism having a second arm that pivots at a base to fixedly secure a second grip in one of various positions.

6. The ballistic shield according to claim 1, further comprising a second offset layer provided over the second handle mechanism.

7. The ballistic shield according to claim 1, further comprising a cover plate that is mechanically coupled to the frame and positioned to overlap the transparent window.

8. The ballistic shield according to claim 1, further comprising a shield extension coupled to the first section through a hinge, wherein the hinge includes a hinge base coupled to the first section, a hinge clip coupled to the shield extension, and a hinge pin that mechanically couples the hinge base and the hinge clip.

9. The ballistic shield according to claim 8, wherein the shield extension is biased at least 10° forward of a plane defined by the first section.

10. The ballistic shield according to claim 1, wherein the first section is constructed from ultra-high-molecular-weight polyethylene and the transparent window is constructed from a transparent ceramic material.

11. A ballistic shield, comprising:
a first section having an outward face exposed to projectiles and an opposing inward face;
a second section comprising:
a frame mechanically coupled to the first section, the frame being substantially coplanar with the first section; and
a transparent window mechanically coupled to the frame; and
a shield extension coupled to the first section through a hinge.

12. The ballistic shield according to claim 11, wherein the first section is dimensioned to protect a human torso and the second section is dimensioned to protect a human head.

13. The ballistic shield according to claim 11, further comprising a first offset layer provided over a boundary area provided between the first section and the second section.

14. The ballistic shield according to claim 11, further comprising a first handle mechanism mechanically coupled to the frame, the first handle mechanism having a first arm that pivots at a base to fixedly secure a first grip in one of various positions.

15. The ballistic shield according to claim 11, further comprising a second handle mechanism mechanically coupled to the inward face, the second handle mechanism having a second arm that pivots at a base to fixedly secure a second grip in one of various positions.

16. The ballistic shield according to claim 11, further comprising a second offset layer provided over the second handle mechanism.

17. The ballistic shield according to claim 11, further comprising a cover plate that is mechanically coupled to the frame and positioned to overlap the transparent window.

18. The ballistic shield according to claim 11, wherein the hinge includes a hinge base coupled to the first section, a hinge clip coupled to the shield extension, and a hinge pin that mechanically couples the hinge base and the hinge clip.

19. The ballistic shield according to claim 18, wherein the shield extension is biased at least 10° forward of a plane defined by the first section.

20. The ballistic shield according to claim 11, wherein the first section is constructed from ultra-high-molecular-weight polyethylene and the transparent window is constructed from a transparent ceramic material.
